(19) United States
(12) Patent Application Publication
(10) Pub. No.: US 2005/0060214 A1
(43) Pub. Date: Mar. 17, 2005

(54) Shelf life/stability studies management

(75) Inventors: Karen Theel, New Fairfield, CT (US); Elaine Wan, New York, NY (US); Sanjay Rastogi, Tarrytown, NY (US); Brenda Stone, Millwood, NY (US); Chetan V. Nagarbandhara, Hartsdale, NY (US); Richard D. Persen, Newburgh, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Oracle International Corporation, Redwood City, CA (US)

(21) Appl. No.: 10/666,403

(22) Filed: Sep. 17, 2003

(51) Int. Cl. G06F 17/60

(52) U.S. Cl. 705/7

(57) ABSTRACT

A computer implemented method for managing a stability or shelf life study is provided. Requirements for a stage in a plurality of stages are determined and interfaces are output that define the requirements. Information may then be input for fulfilling the requirements. The input information is then validated against business rules that define logic to determine if the input information is acceptable. The input information is then stored.

### BACKGROUND OF THE INVENTION

The present invention generally relates to shelf life or stability studies and more specifically to apparatus and methods for managing a shelf life or stability study.

Shelf life or stability studies are performed in the life science, chemical, and food industries to determine the effects of environmental conditions on the quality of a product, its shelf life and the viability of its formulation. The studies also provide data that companies use to establish product expiration dating. Further, the studies may be used to conform the product to state or country regulations.

Performing a study involves multiple steps, such as the definition of the study, the establishment of a number of samples, the establishment of sampling dates and procedures, and the recording of the results from sampling. The tasks for each of the steps of the study are manually determined. Also, the information or results of the tasks are typically recorded in various notebooks or spreadsheets by different users. The recorded information is often not easily shared between users. Thus, retrieval of historical data for analysis and comparison is often difficult and time-consuming.

Accordingly, automated techniques for managing a stability or shelf life study are desired.

### BRIEF SUMMARY OF THE INVENTION

Embodiments of the present invention relate to a computer implemented method for managing a stability or shelf life study. Requirements for a stage in a plurality of stages are determined and interfaces are output that define the requirements. Information may then be input for fulfilling the requirements. The input information is then validated against business rules that define logic to determine if the input information is acceptable. The input information is then stored.

In one embodiment, a computer implemented method for managing a stability study is provided. The method comprises: generating one or more interfaces for the stability study, wherein the one or more interfaces define requirements for the stability study; displaying the one or more interfaces; receiving input information for the one or more interfaces, the received input information for fulfilling the requirements; validating the received input information against business rules to determine if the input information is acceptable; and if the input information is acceptable, storing the input information.

In another embodiment, a method for managing a stability study is provided. The method comprises: (a) determining a criterion in a plurality of criteria needed to complete the stability study; (b)outputting information for one or more requirements for the criterion; (c) receiving information needed to complete the one or more requirements for the criterion based on the information outputted; (d) validating the received information to determine if the one or more requirements are satisfied; and (e) if the one or more requirements have been satisfied, repeating steps (a)-(e) for another criteria in the plurality of criteria until the plurality of criteria have been completed.

A further understanding of the nature and advantages of the invention herein may be realized by reference of the remaining portions in the specifications and the attached drawings.

### BRIEF DESCRIPTION OF THE DRAWINGS

FIG. 1 illustrates a simplified flow chart of a method for managing a stage in a stability study according to one embodiment of the present invention.

FIG. 2 illustrates a simplified flowchart of a method for managing a plurality of stages in a stability study according to one embodiment of the present invention;

FIG. 3 illustrates a system for managing a stability study according to one embodiment of the present invention;

FIG. 4 illustrates a plurality of stages that may be included in a stability study according to one embodiment of the present invention; and

FIGS. 5-8 depict embodiments of interfaces used for the plurality of stages.

FIG. 9 is a simplified block diagram of a data processing system that may incorporate an embodiment of the present invention;

### DETAILED DESCRIPTION OF THE INVENTION

Embodiments of the present invention provide methods and apparatus for managing a shelf life or stability study. A shelf life or stability study may be any study that studies the effects of environmental conditions on the quality of a product, its shelf life, and the viability of its formulation. In one embodiment, the purposes of performing a stability or shelf life study include accessing how much material quality changes with the changing of environmental factors, such as temperature, relative humidity, or pressure; determining the shelf life and recommended storage conditions for materials; and establishing a retest period for manufactured batches. A person of skill in the art may appreciate other aspects of a stability or shelf life study that are needed. For discussion purposes, a stability or shelf life study will be referred to herein as a “stability study”.

Embodiments of the present invention provide a graphical user interface (GUI) that outputs forms and workflows that are created to establish and monitor all facets of a stability study. The forms define requirements that need to be fulfilled for the stability study. Also, the workflows provide information on actions that should be taken and also link to the form that receives input for the results of those actions. The inputted information is then validated and stored in a central database. Accordingly, all information for a stability study can be stored in a central database.

In one embodiment, a stability study may include any number of stages, such as a stability study setup stage, a stability study planning stage, an initial sampling and testing stage, a stability study launch stage, a stability study testing stage, and a stability study evaluation stage. In order for a stability study to be completed, each stage in the plurality of stages should be completed. An interface may be output for each stage that defines the requirements that need to be completed for the stage. The interface may also output information on actions that should be taken during the stage. Although the above stages are described, it will be understood that any number of stages may be used and a person of skill in the art will appreciate other stages in a stability study.

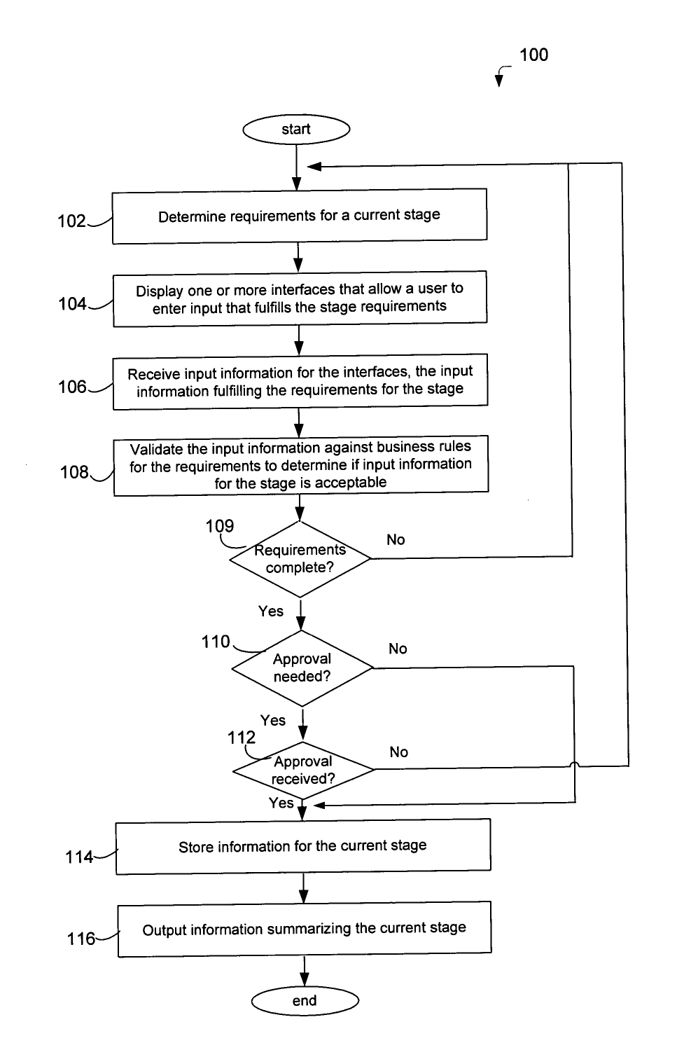

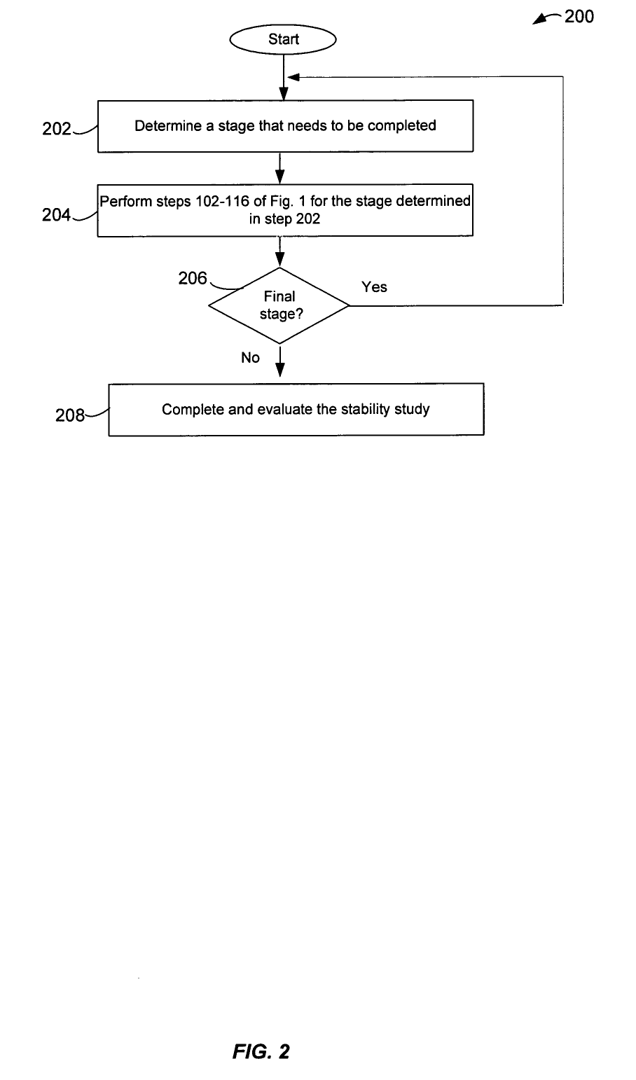

FIG. 1 illustrates a simplified flow chart 100 of a method for managing a stage in a stability study according to one embodiment of the present invention. In step 102, one or more requirements are determined for a current stage. In one embodiment, a plurality of stages may be processed. Each stage includes one or more requirements or criteria that need to be completed in order to complete the stage. For example, in a stability study planning stage, the requirements include what is needed for approving the stability study plan.

In step 104, one or more interfaces are displayed that allow a user to input information for fulfilling the stage requirements. For example, initial information identifying a stability study that may be created may be received. Workflows may then be launched that to identify actions that need to be taken by a user. When the actions are completed, an interface may be outputted and displayed that allows a user to enter the results of the actions that were taken. Thus, workflows prompt for actions that need to be taken during a stage.

Using the above example, interfaces that allow a user to plan different facets of the stability study are output. These interfaces are automatically generated. Thus, a user may not need to generate any of the requirements that need to be completed for the stability study.

In step 106, input information for the interfaces is received. The input information is information for fulfilling the requirements for the stage. For example, the information of the results of the actions required by the workflows may be entered. Tests may be performed and the results of the tests may be inputted in the interface. Also, information defining the study may be received and later used to develop the stability study. Using the above example, a user may identify material sources and the number of samples per variant time point in order to develop the stability study plan.

In step 108, the received input information is validated against business rules for the requirements to determine if the input information for the stage is acceptable. The business rules define the logic to validate data in order for a stage to be completed. For example, the business rules may be used to validate that acceptable material sources are entered and that sufficient sample quantity for all samples exists.

In step 109, it is determined if the requirements for the stage have been completed. If the requirements for the stage have not been completed, the process reiterates to step 102. Interfaces to complete the requirements may then be output and a user may then input information to fulfill the requirements. For example, additional interfaces may be output that direct a user to perform actions. Also, some requirements may not have been satisfied and additional interfaces requiring information for the requirements may be output.

In step 110, embodiments of the present invention determine if approval is needed for the stage. In some cases, a stage should be approved by a user in order for the stability study to proceed. Additionally, regulations may require that a stage be approved in order for it to be completed. In one embodiment, the option of receiving an approval may be turned on and off by an administrator for the stability study. For example, a user may change the status for the stability study to require approval for proceeding to the next stage.

If approval is needed, in step 112, it is determined if approval is received for the stage. In one embodiment, the indication of an approval may be a digital signature, or any other indication of approval, such as a captured handwritten signature. If a user does not approve the stage, the process reiterates to step 102, where it is determined which requirements still need to be completed. Interfaces may then be outputted and the processing of the stage continues.

If approval is not needed or after approval is received in step 112, information for the current stage is stored in a database in step 114. The database may be a central repository that stores all information for the stability study. Thus, stored information from different stages may be used for a current stage being processed. Also, retrieval of inputted information is also facilitated because information from previous stages is stored in a central repository.

In step 116, information is outputted that summarizes the current stage. The information may be used by a user in other stages or for a record of the completed stage.

FIG. 2 illustrates a simplified flowchart 200 of a method for managing a plurality of stages for a stability study according to one embodiment of the present invention. In step 202, information for a stage in a plurality of stages is determined. In one embodiment, the stages may include at least a stability study setup stage, a stability study planning stage, an initial sampling and testing stage, a stability study launch stage, a stability study testing stage, and a stability study evaluation stage. A stage includes one or more criteria that need to be completed for the study. For example, the stage may require input information of results of tests performed on a material. Although certain stages are discussed, it will be understood that embodiments of the present invention are not limited to the discussed stages. A person skilled in the art will appreciate any number of criteria required for a stability study.

In step 204, steps 102-116 of FIG. 1 are performed. Thus, the current stage is completed using the functions described in FIG. 1.

In step 206, it is determined if another stage needs to be completed for the stability study. In one embodiment, completion of each stage in the plurality of stages proceeds in a sequential manner. For example, completion of one stage is necessary before a next stage is initiated.

In step 208, if another stage does not need to be completed, the stability study is completed and evaluated. In one embodiment, a user may determine a recommended shelf life, and/or storage conditions. For example, the stored information may be outputted in an interface and a user may determine and input an evaluation for the stability study. The evaluation is then stored in the database.

Accordingly, a stability study has been completed when the last stage is completed. One or more interfaces for each stage of the stability study are automatically generated with information that defined information needed for the stage. Also, the interfaces define any necessary actions for the stage and information needed for the results of the actions. Once the necessary information is inputted for all of the stages, the stability study may be evaluated and completed. All information that was inputted for all of the stages is also stored in the database.

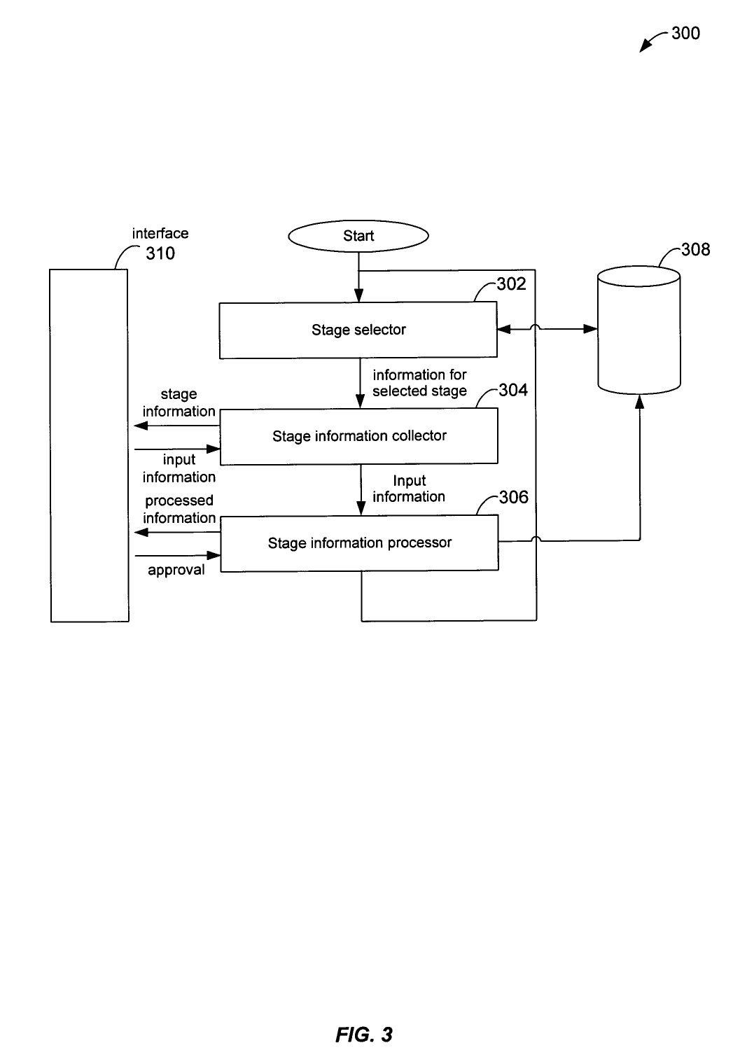

FIG. 3 illustrates a system 300 for managing a stability study according to one embodiment of the present invention. System 300 includes a stage selector 302, a stage information manager 304, a stage information processor 306, and a database 308. Stage information manager 304 and stage information processor 306 communicate with an interface 310 to output information and receive inputted information. Interface 310 defines requirements that need to be satisfied for the stability study. Also, inputted information in interface 310 is stored in database 308.

Stage selector 302 is configured to select a stage that will be currently processed and to determine information needed for the selected stage from database 308. For example, a stability study may include a plurality of stages that will be processed. Stage selector 302 is configured to determine which stage to process and also to retrieve any information needed for the stage from database 308. The information may define requirements needed or actions to perform for the stage. Accordingly, stage selector 302 performs the functions described in step 202 of FIG. 2.

Stage information manager 304 receives the requirements for the selected stage from stage selector 302 and outputs an interface 310 for the selected stage. Input information for the outputted stage information is then received by Stage information manager 304 through interface 310. Interface 310 includes entries that define information needed to complete the stage and may also define actions that need to be performed. Accordingly, Stage information manager 304 performs the functions described in steps 102, 104, and 106 of FIG. 1.

Stage information processor 306 receives the inputted information from Stage information manager 304 and processes the information. The information is validated against business rules to determine if the requirements for the stage have been fulfilled. Also, information may be output to interface 310 for approval by a user. When an indication of approval is received through interface 310, stage information processor 306 stores the information in database 308. Stage information processor 306 then determines if another stage needs to be completed. If another stage needs to be completed, stage selector 302 is contacted and another stage is selected for processing. Accordingly, stage information processor 306 performs the functions described in steps 108, 109, 110, 112, 114, and 116 of FIG. 1 and steps 206 and 208 of FIG. 2.

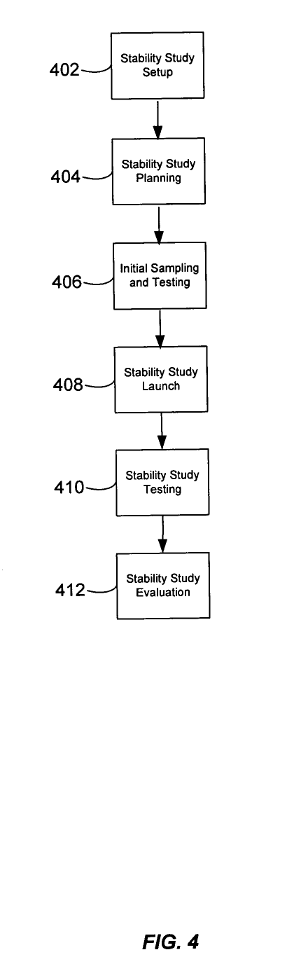

FIG. 4 illustrates a plurality of stages that may be included in a stability study according to one embodiment of the present invention. Although the following stages will be described, it will be understood that the stability study is not limited to the described stages and other variations of stages may be included in the stability study. The plurality of stages include certain criteria that need to be completed. In one embodiment, the stages as described are performed in a sequential manner where completion of one stage is necessary in order to move to the next stage. It will be understood, however, that multiple stages may be completed in parallel and may not be dependent upon one another.

In a stage 402, the building blocks or templates for a stability study are initially set up. An interface is outputted that defines requirements for the stability study setup and actions that need to be performed. For example, the interface provides information defining test interval plans; storage condition plans; storage packages; and monitoring and item stability specifications. The components of the interfaces may be reused for multiple studies and may be used for the same item or different item. Base and overlay components are used to create new test interval plans and monitoring and item stability test specifications. A base specification may be used and overlaps may be created to capture variations in the base specifications.

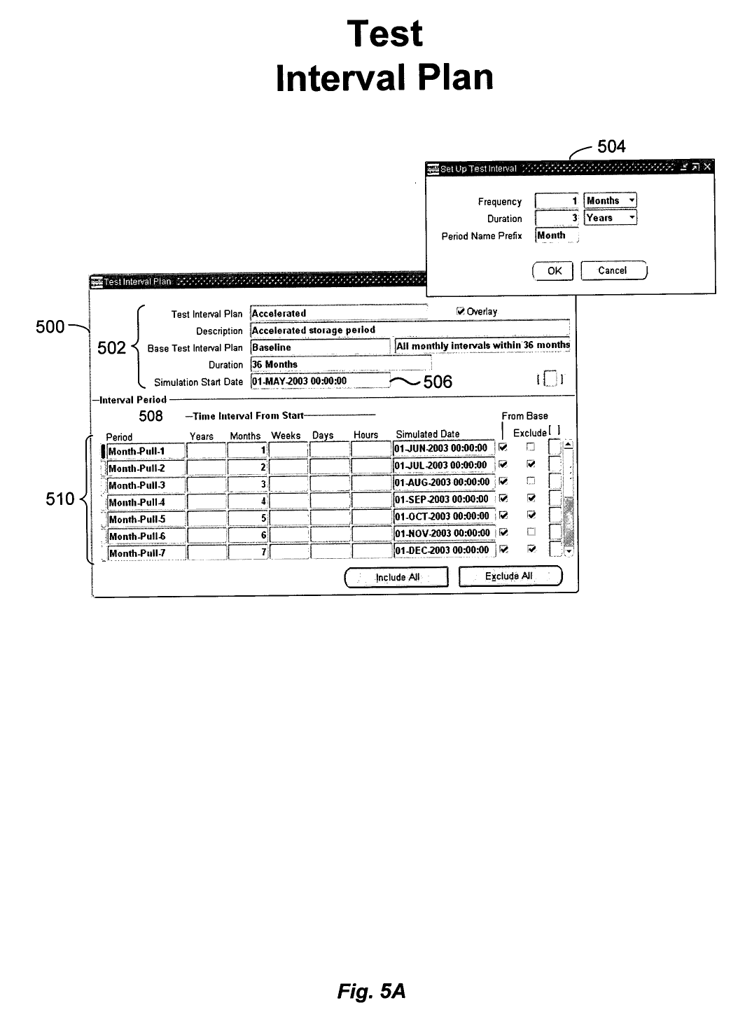

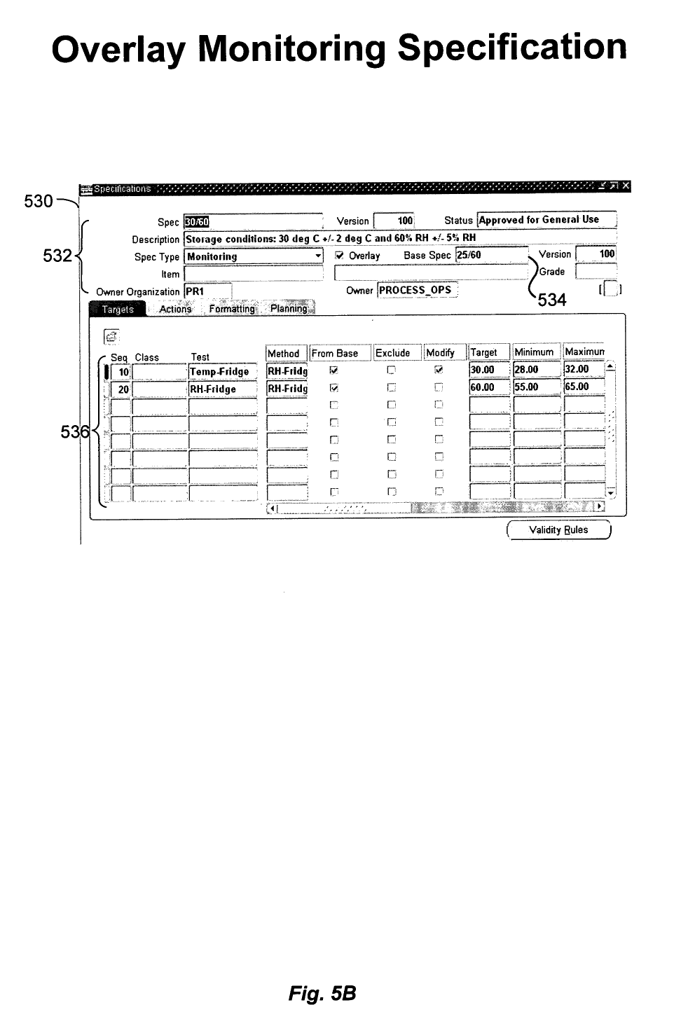

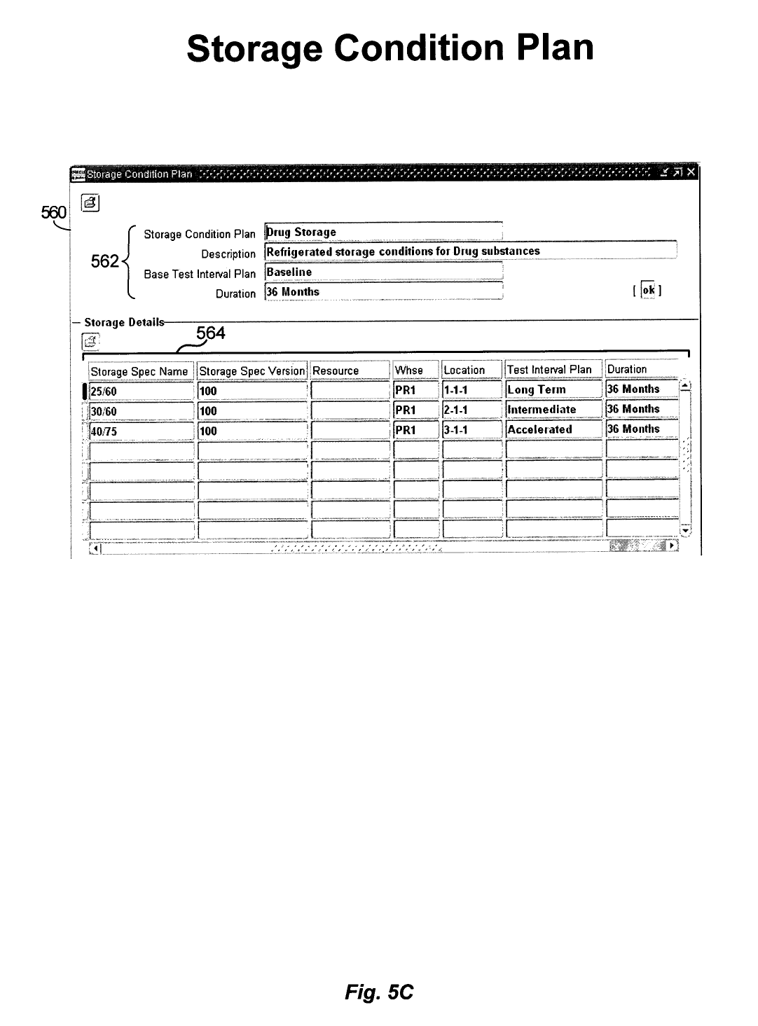

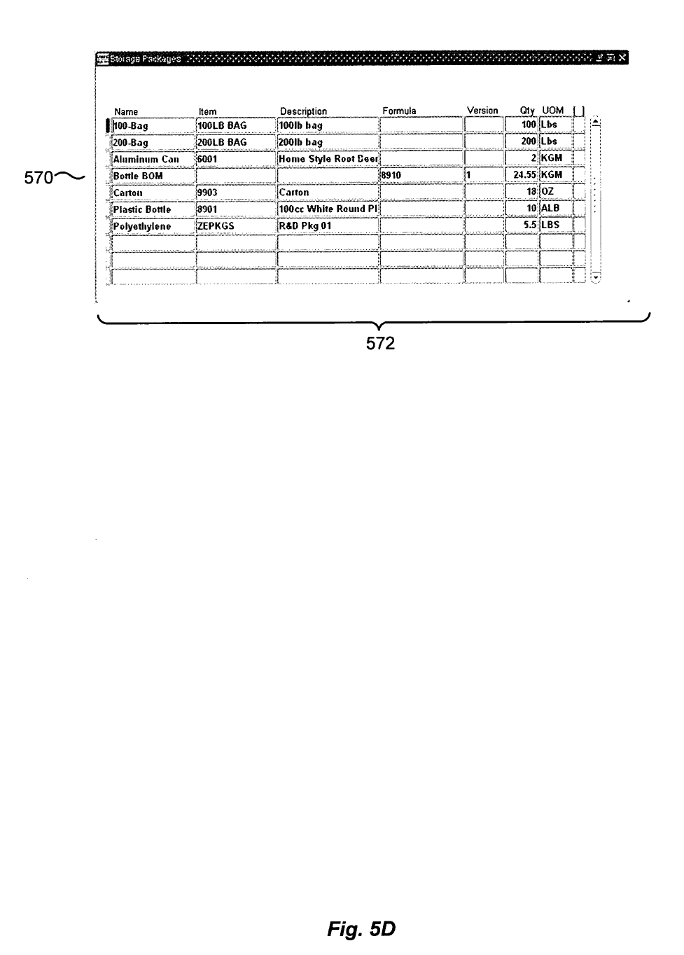

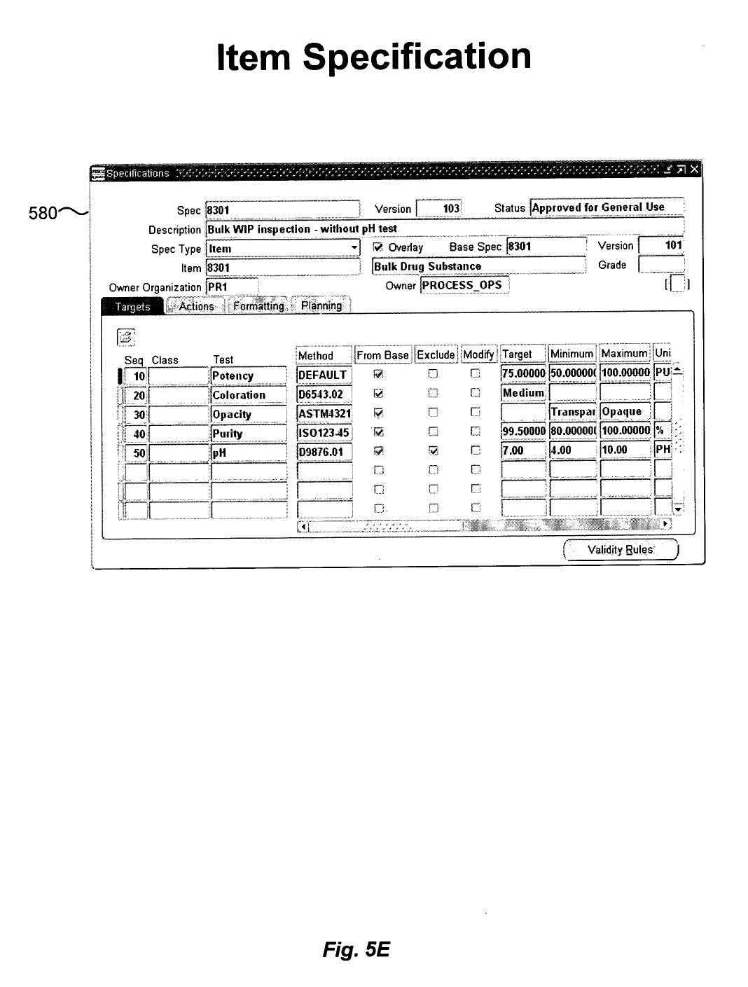

FIGS. 5A, 5B, 5C, 5D, and 5E depict interfaces used to define test intervals; storage conditions; storage packages; and monitoring and item stability specifications according to one embodiment of the present invention. Although these interfaces are shown, it will be understood that other interfaces will be appreciated.

FIG. 5A depicts an interface 500 that defines a base or overlay test interval plan according to one embodiment of the present invention. As shown, a plurality of entries 502 are provided that allow a user to enter information defining the base test interval plan. A set-up test interval window 504 allows a user to quickly generate a series of test intervals by specifying the frequency, duration, and period name prefix for the test interval. In this case, the interval may be generated for every month for three years.

This information is outputted in entries 510 along with an input for the simulation start date 506. The user can also enter an interval period 508 without using setup test window 504. Entries 510 from the months June-December are shown and additional months up to the 36-month duration may be provided by interface 500 (not shown). When creating an overlay, the user also has a choice to include or exclude entries 510 from the base interval plan. For example, each entry represents a point when a sample should be pulled and tested. The user may exclude an entry and thus would not pull the sample at that time.

FIG. 5B depicts an interface 530 defining monitoring specifications according to one embodiment of the present invention. Monitoring specifications define environmental monitoring conditions independent of stability testing. For example, a base monitoring specification and additional overlay monitoring specifications may be defined for the stability study. The monitoring specifications may be created off a base template and any changes are created as overlay monitoring specifications. Thus, a base criterion is used to create testing conditions that can be modified. The overlay monitoring specifications include differing storage conditions, for example, temperature and relative humidity, from the base monitoring specification.

As shown, a plurality of entries 532 are provided that define information for monitoring specifications for the stability study. A base specification entry 534 is provided to identify the base specification and entries for configuring test values 536 provided to create overlay specifications. Once the base monitoring specifications and overlay monitoring specifications are defined, the information is stored in database 308.

FIG. 5C illustrates an interface 560 that defines information needed for a storage condition plan according to one embodiment of the present invention. A plurality of entries 562 define information for the storage condition plan that correlates the base and overlay interval plan to the base and overlay monitoring specifications. A user may input information or retrieved from database 308. Information about storage details 564 is also provided by interface 560. Entries 564 allow a user to define storage conditions for the stability study.

FIG. 5D illustrates an interface 570 that defines information for storage packages according to one embodiment of the present invention. Storage packages identify a container closure system as an item or formula (build of materials). A storage package is a material used to store a stability sample. It may be a formula (or bill of materials) if there are multiple components to the packaging (e.g., plastic bottle, cotton insert, plastic cap).

Interface 570 includes a plurality of entries 572 that are used to define storage packages for the stability study. A user may input information to define the storage packages.

FIG. 5E depicts an interface 580 that defines an item specification according to one embodiment of the present invention. Item specifications define the item stability criteria to be tested across time points. An item base specification may include pH, purity, and contaminant tests. Item overlay specifications may include different variations of the base specifications, such as adding or excluding tests or changing the test target or range values.

Interface 580 includes entries that allow the definition of different combinations of test and their target values by creating item base and overlay specifications. A user may input information to define the item base and overlay specifications.

When information has been inputted using the above interfaces 530 and 580, business rules are used to validate the monitoring and item specifications inputted. If approval is received or not needed, the process continues to the next stage.

Information may be input by a user to satisfy the requirements for the interfaces depicted in FIGS. 5A-5E and/or system 300 may generate information for the entries using information in database 308. When all information has been inputted into the interfaces, the information is stored in database 308.

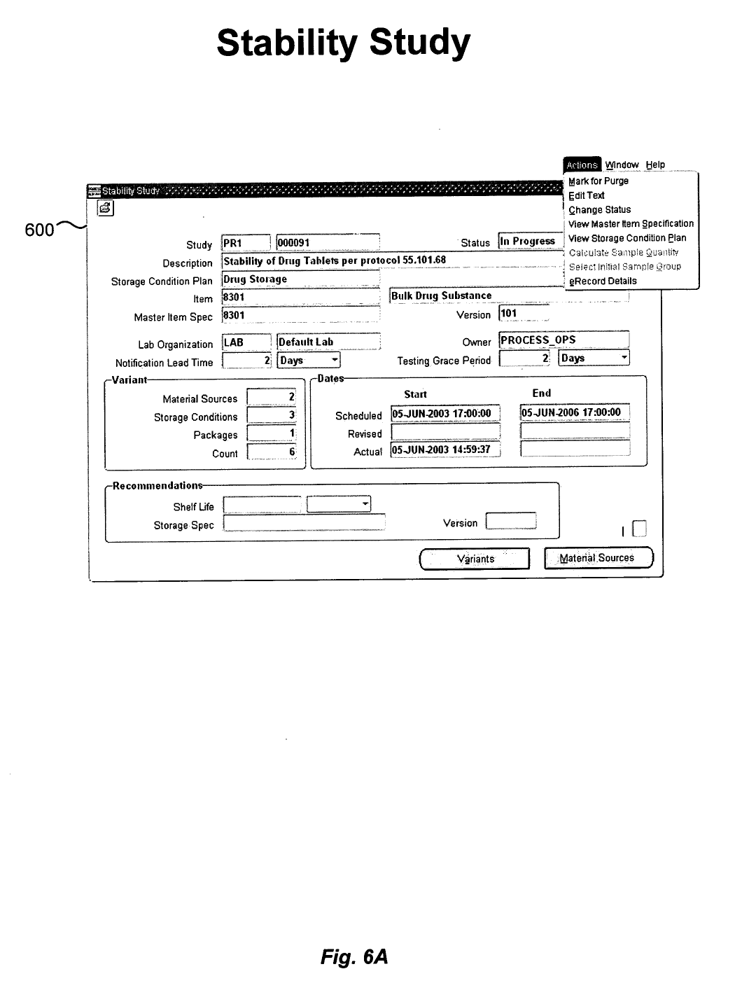

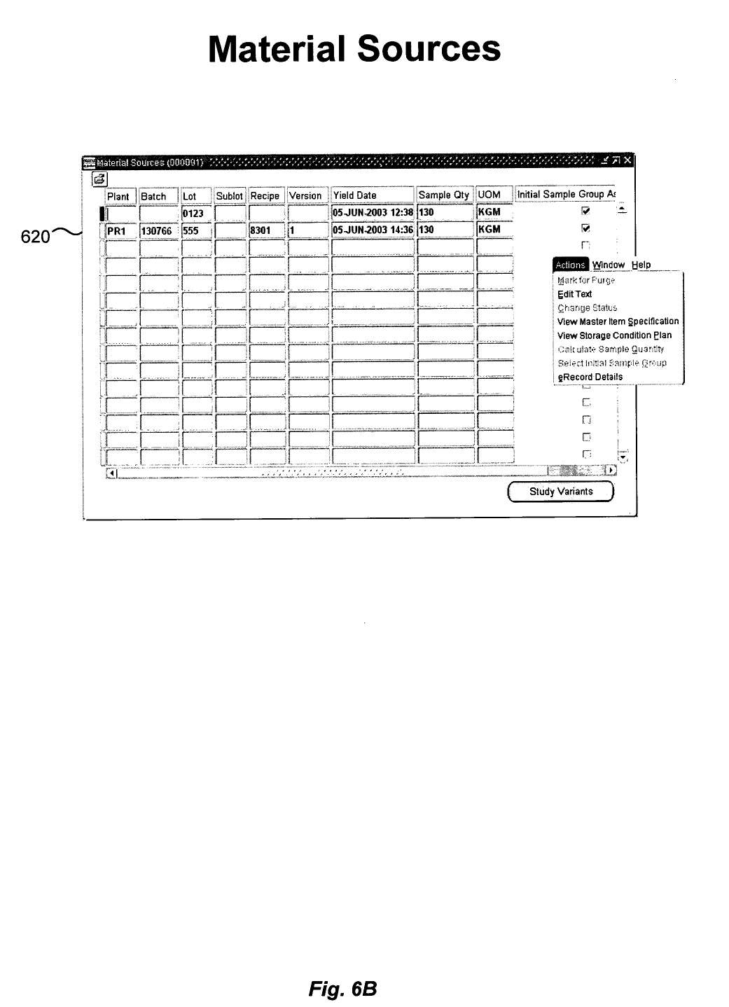

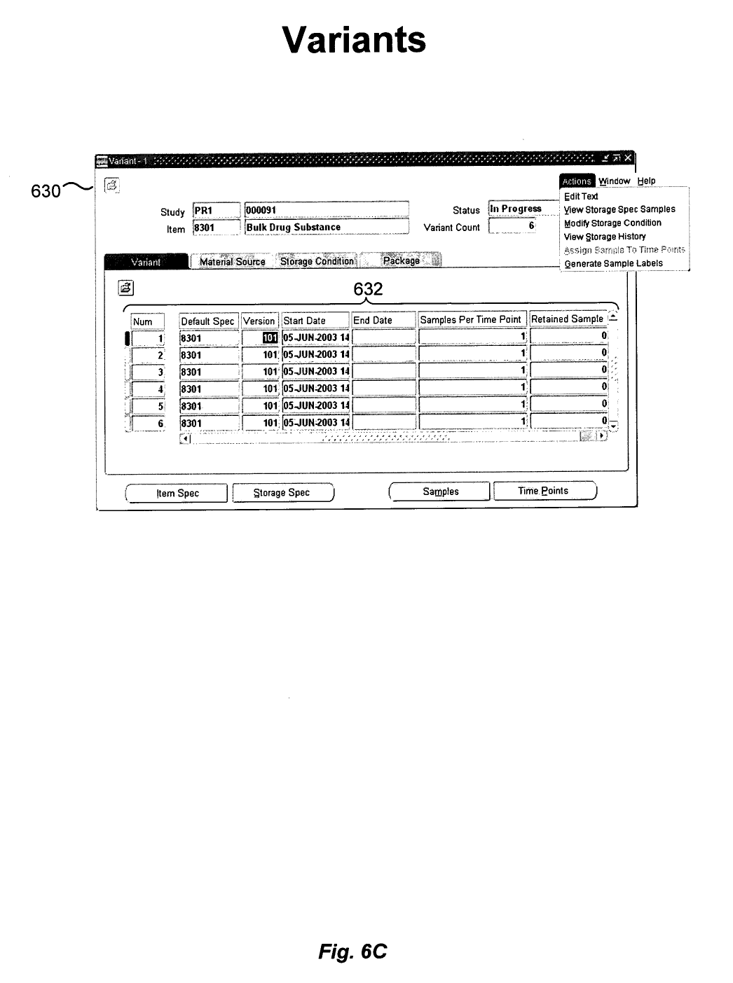

In a stage 404, stability study planning is performed. An interface is outputted that defines the requirements needed to plan a stability study. In one embodiment, the requirements include that a storage condition plan is created, material sources are identified, and variants and time points are planned. FIGS. 6A-6C depict interfaces that define the information needed or actions that need to be performed to complete the stability studying planning stage. Although these interfaces are shown, it will be understood that other interfaces will be appreciated.

FIG. 6A depicts an interface 600 that defines information needed to create and maintain an item specific stability study. Interface 600 may include entries for information such as a study name, a protocol, storage conditions and default item stability specifications, a testing laboratory and study owner, study start and end dates, notification time windows, the number of material sources and storage packages to determine a variant count, etc.

FIG. 6B depicts an interface 620 that defines information for material sources according to one embodiment of the present invention. Interface 620 defines information needed in order to select or request batches as a basis for the stability study. In selecting an existing batch material, a batch number and lot number may be inputted. In requesting a new batch material, the plant and/or plant recipe and version may be input. A workflow may then be generated and output that includes a notification to create a batch according to the inputted information so that stability samples can be taken from the batch.

FIG. 6C depicts an interface 630 that defines information needed for defining variants in the stability study according to one embodiment of the present invention. Variants are created from different combinations of a material source, storage condition, and storage package. The variants may be created by a user or generated by system 300. The variants may be configured differently by specifying samples for a time point; retained samples, start date, storage condition (resource/instance or warehouse/location), storage package and sample quantity. As shown, entries 632 are provided to define information for the variants.

Information may be input by a user to satisfy the requirements for the interfaces depicted in FIGS. 6A-6C and/or system 300 may generate information for the entries using information in database 308. When all information has been inputted into the interfaces, the information is stored in database 308.

Business rules may be used to validate the material sources. For example, system 300 may validate that each material source has a lot number identified and has an acceptable initial sample group. If approval is required, the plan should be approved by a user. After approval is received or if it is not needed, the variants and time points for sampling are planned and outputted.

In a stage 406, an interface for initial sampling and testing is outputted. In one embodiment, a requirement for the stage is that the material sources are acceptable for testing. The interface identifies source materials to be tested. The initial samples may then be created, tested, and dispositioned. A user may input information that captures the initial sampling and testing that has taken place by associating an initial sample group (e.g., a lot number) to the material source. Business rules are then used to validate that a lot number for the source material that has been entered and an initial sampling group for the source has been associated. If a lot number is not identified for the material source, a workflow may be outputted that requests for a material to be made through a batch.

An approval may be required to determine if it is acceptable to proceed to launch status for the study. After approval is received or if it is not required, acceptable material sources are identified and output. Also, at this time, a user can generate time point labels for the samples, put the materials in storage packages for each sample, and put the samples in each storage condition for each variant.

In a stage 408, a stability study launch is performed. An interface that defines requirements for the stability study launch is outputted. For example, the requirements may be that acceptable material sources are validated. The interface includes information for launching the approved stability study, scheduling variant time point testing, information for packaging, labeling, and storing stability samples and storage conditions, and information for scheduling environmental monitoring. An approval may be required to launch the study and an interface may be outputted that indicates the study is in launch status if approval is received or not required. This study start date reflects when the study is launched.

In a stage 410, stability study testing is performed. An interface is outputted that defines requirements needed for the testing stage. In one embodiment, the interface includes requirements for pulling and testing samples at each time point until testing is complete and information needed to monitor environmental conditions periodically. Also, another requirement is that each sample has been dispositioned. Workflows may be outputted that define when to pull samples from storage for testing at each variant time point and when testing is to start or is overdue.

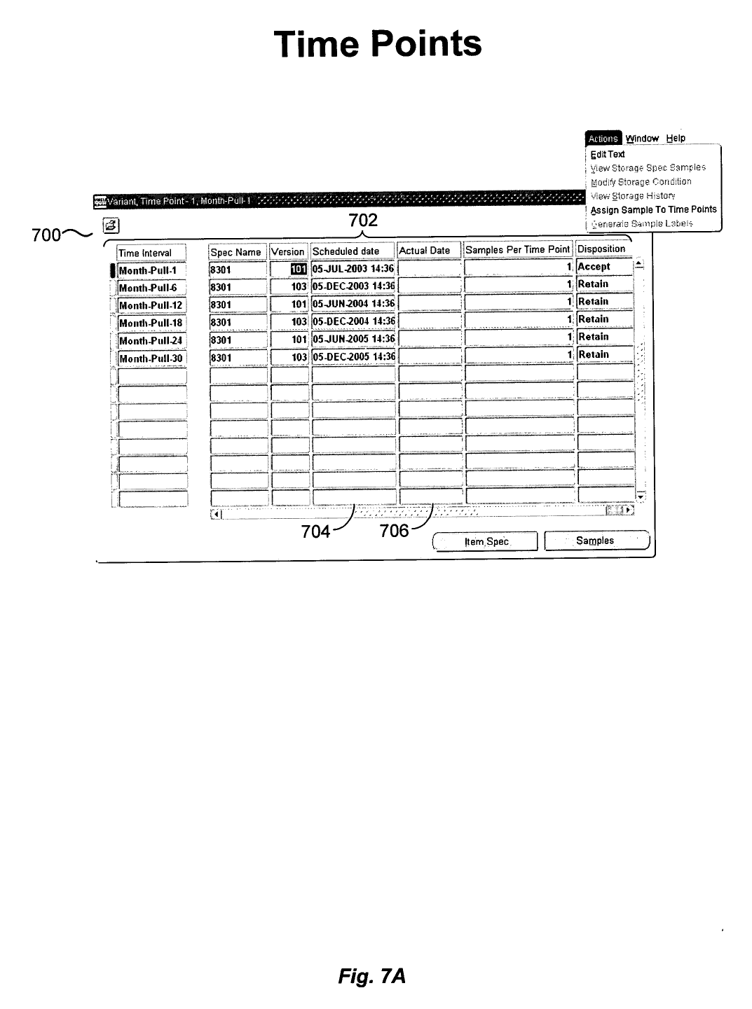

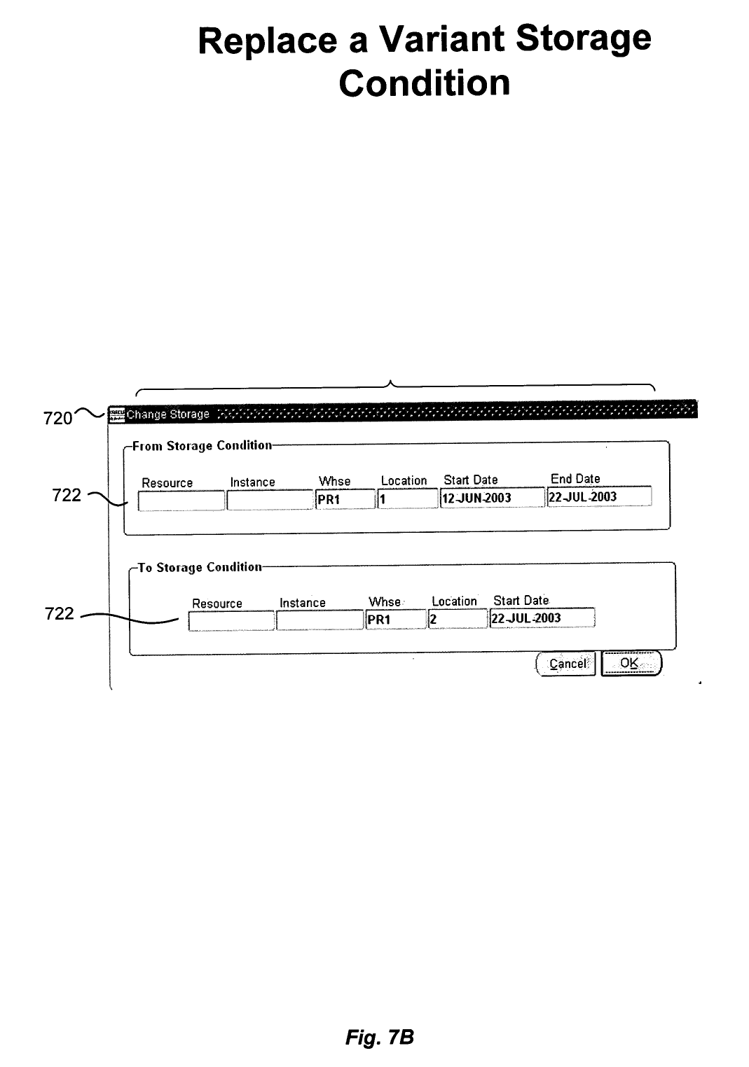

Once testing is completed at each time point, a user may input information using the interface. The information is then stored in database 308. FIGS. 7A and 7B depict interfaces outputted for stability study testing according to one embodiment of the present invention. Although these interfaces are shown, it will be understood that other interfaces will be appreciated.

FIG. 7A depicts an interface 700 that displays the current status of time point testing for a variant according to one embodiment of the present invention. The list of time point variants show when samples should be pulled for testing. For example, samples are uniquely pulled at different time points. Flexible scheduling actions for time point testing is supported. The interface allows a user to start time point testing, add a time point, and cancel a time point. Interface 700 defines information that defines when time point testing for a variant should be performed (only one variant is shown). Entries 702 define the time point testing and results may be inputted by a user. System 300 generates information defining the time points, such as the dates found in a “Scheduled date” column 704. Information for an “Actual date” column 706 will then be input by a user depending on the action date the testing took place. Once information in entries 702 is inputted, the information may be stored in database 308.

FIG. 7B depicts an interface 720 that allows a user to replace the storage conditions for a variant according to one embodiment of the present invention. A workflow may be generated to for an out-of-specification condition based on a monitoring specification sample and result where the user can change the resource or location of the storage condition. For example, entries 722 may be used to specify the storage condition replacement and date of replacement. The modification may then be stored in database 308 and used to modify any information associated with storage conditions.

The results of the stability testing and environmental monitoring may be validated. For example, system 300 may check that a disposition for each stability sample has been input and may monitor the storage conditions to determine if any errors have occurred during testing, such as a refrigerator has gone offline, etc. Approval may also be given if it is determined that testing is completed.

In a stage 412, the stability study is completed. An interface is outputted that defines requirements needed to complete the stability study. For example, a requirement may be that a user determines that testing is completed. A user may determine if the stability study is completed using the time point screen, stability study screen and variant screen. Also, the user may use the interface to note the ideal shelf life and storage conditions based on the outcome of the stability testing of the material. Approval may be received indicating that the study is completed. Also, an interface showing the shelf life and storage conditions and end date of the study may be outputted.

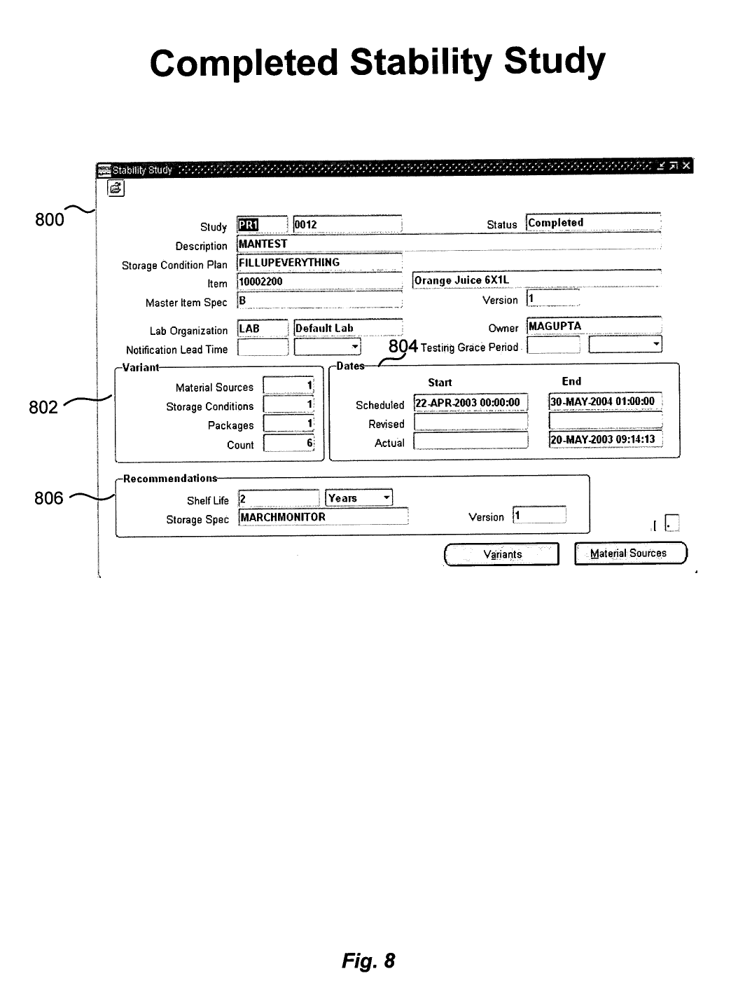

FIG. 8 illustrates an interface 800 that defines information needed for completing a stability study according to one embodiment of the present invention. Interface 800 summarizes the study variants 802, dates 804, and recommendations 806. Variants 802 define different variants that were tested in the stability study. Dates 804 include the scheduled and actual start and end dates and any revised dates of the stability study. Recommendations 806 include shelf life recommendations and ideal storage conditions based on the user's interpretation of the stability testing results.

A user may input information to define the completed stability study and/or system 300 may generate information for the entries using information in database 308. Information inputted is stored in database 308.

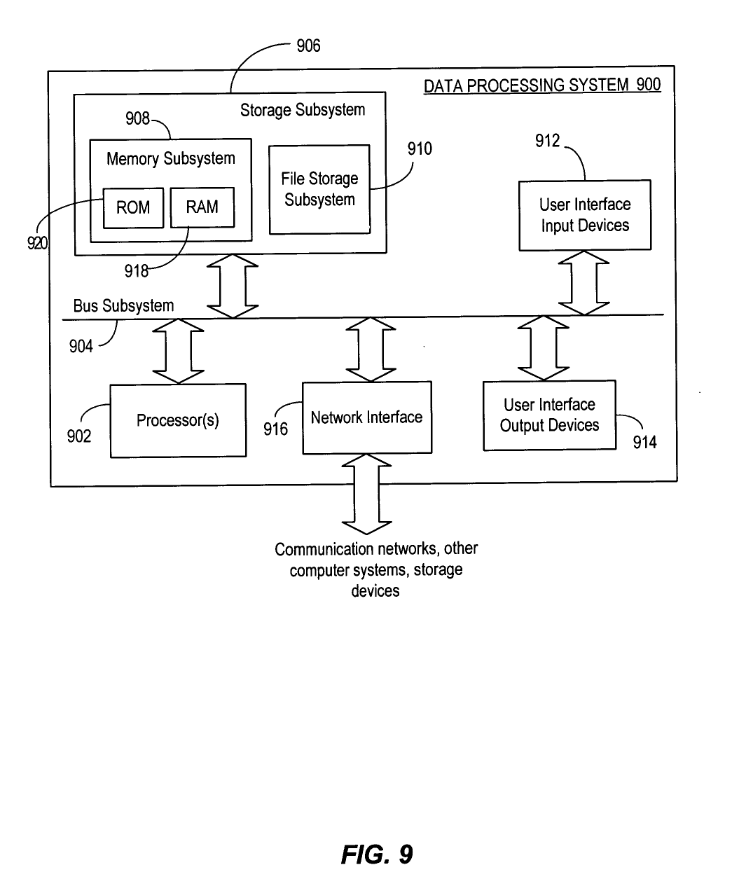

FIG. 9 is a simplified block diagram of a data processing system 900 that may incorporate an embodiment of the present invention. As shown in FIG. 9, data processing system 900 includes at least one processor 902, which communicates with a number of peripheral devices via a bus subsystem 904. These peripheral devices may include a storage subsystem 906, comprising a memory subsystem 908 and a file storage subsystem 910, user interface input devices 912, user interface output devices 914, and a network interface subsystem 916. The input and output devices allow user interaction with data processing system 902.

Network interface subsystem 916 provides an interface to other computer systems, networks, and storage resources 904. The networks may include the Internet, a local area network (LAN), a wide area network (WAN), a wireless network, an intranet, a private network, a public network, a switched network, or any other suitable communication network. Network interface subsystem 916 serves as an interface for receiving data from other sources and for transmitting data to other sources from data processing system 900. For example, may receive the images to be compared via network interface subsystem 916. Embodiments of network interface subsystem 916 include an Ethernet card, a modem (telephone, satellite, cable, ISDN, etc.), (asynchronous) digital subscriber line (DSL) units, and the like.

User interface input devices 912 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and ways to input information to data processing system 900.

User interface output devices 914 may include a display subsystem, a printer, a fax machine, or non-visual displays such as audio output devices. The display subsystem may be a cathode ray tube (CRT), a flat-panel device such as a liquid crystal display (LCD), or a projection device. In general, use of the term “output device” is intended to include all possible types of devices and ways to output information from data processing system 900.

Storage subsystem 906 may be configured to store the basic programming and data constructs that provide the functionality of the present invention. For example, according to an embodiment of the present invention, software modules implementing the functionality of the present invention may be stored in storage subsystem 906. These software modules may be executed by processor(s) 902. Storage subsystem 906 may also provide a repository for storing data used in accordance with the present invention. For example, the images to be compared including the input image and the set of candidate images may be stored in storage subsystem 906. Storage subsystem 906 may comprise memory subsystem 908 and file/disk storage subsystem 910.

Memory subsystem 908 may include a number of memories including a main random access memory (RAM) 918 for storage of instructions and data during program execution and a read only memory (ROM) 920 in which fixed instructions are stored. File storage subsystem 910 provides persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Bus subsystem 904 provides a mechanism for letting the various components and subsystems of data processing system 900 communicate with each other as intended. Although bus subsystem 904 is shown schematically as a single bus, alternative embodiments of the bus subsystem may utilize multiple busses.

Data processing system 900 can be of varying types including a personal computer, a portable computer, a workstation, a network computer, a mainframe, a kiosk, or any other data processing system. Due to the ever-changing nature of computers and networks, the description of data processing system 900 depicted in FIG. 9 is intended only as a specific example for purposes of illustrating the preferred embodiment of the computer system. Many other configurations having more or fewer components than the system depicted in FIG. 9 are possible.

While the present invention has been described using a particular combination of hardware and software implemented in the form of control logic, it should be recognized that other combinations of hardware and software are also within the scope of the present invention. The present invention may be implemented only in hardware, or only in software, or using combinations thereof.

Although embodiments of the present invention are described in the context of stability studies, it will be understood that the present invention is not restricted to use in stability studies.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A computer implemented method for managing a stability study, the method comprising:
generating one or more interfaces for the stability study, wherein the one or more interfaces define requirements for the stability study;
displaying the one or more interfaces;
receiving input information for the one or more interfaces, the received input information for fulfilling the requirements; and
validating the received input information against business rules to determine if the input information is acceptable.

2. The method of claim 1, further comprising if the input information is acceptable, storing the input information.

3. The method of claim 1, further comprising:
determining if the requirements for the stability study have been completed; and
if the requirements have not been completed, outputting an interface for additional input information for the requirements that have not been completed.

4. The method of claim 1, further comprising:
determining if approval from a user is needed for the input information.

5. The method of claim 4, further comprising:
receiving an indication of approval from the user; and
storing the indication.

6. The method of claim 5, wherein the indication comprises at least one of an electronic signature and captured signature.

7. The method of claim 5, further comprising:
receiving an indication from the user of disapproval;
determining requirements that need to be completed for approval; and
outputting an interface needed to complete the determined requirements.

8. The method of claim 1, wherein the one or more interfaces include an interface for a stage in a plurality of stages in the stability study.

9. The method of claim 8, wherein the plurality of stages comprise at least two of a stability study setup criteria, stability study planning criteria, initial sampling and testing criteria, stability study launch criteria, stability study testing criteria, arid stability study evaluation criteria.

10. The method of claim 1, further comprising outputting information summarizing the stability study.

11. The method of claim 1, further comprising determining a result of the stability study.

12. The method of claim 11, wherein the result is inputted by a user.

13. A computer implemented method for managing a stability study, the method comprising:
(a) determining a criterion in a plurality of criteria needed to complete the stability study;
(b) outputting information for one or more requirements for the criterion;
(c) receiving information needed to complete the one or more requirements for the criterion based on the information outputted;
(d) validating the received information to determine if the one or more requirements are satisfied; and
(e) if the one or more requirements have been satisfied, repeating steps (a)-(e) for another criteria in the plurality of criteria until the plurality of criteria have been completed.

14. The method of claim 13, wherein the plurality of criteria comprise at least two of a stability study setup criteria, stability study planning criteria, initial sampling and testing criteria, stability study launch criteria, stability study testing criteria, and stability study evaluation criteria.

15. The method of claim 13, further comprising storing the received information.

16. The method of claim 13, further comprising:
determining if the requirements for the criterion have been completed; and
if the requirements have not been completed, outputting information needed for the requirements that have not been completed.

17. The method of claim 13, further comprising:
determining if approval from a user is needed for the criterion.

18. The method of claim 17, further comprising:
receiving an indication of approval from the user; and
storing the indication.

19. The method of claim 18, wherein the indication comprises at least one of an electronic signature and captured signature.

20. The method of claim 17, further comprising:
receiving an indication from the user of disapproval;
determining requirements that need to be completed for approval; and
outputting an interface needed to complete the determined requirements.

21. The method of claim 13, further comprising storing at least a portion of the received information.

22. The method of claim 13, further comprising outputting information summarizing the stability study.

23. The method of claim 13, further comprising:
receiving specifications for establishing the stability study; and
generating the plurality of criteria based on the specifications.

24. The method of claim 13, wherein validating the received input information comprises validating the received input information against business rules that define whether input information is acceptable.

25. The method of claim 13, further comprising determining a result of the stability study.

26. The method of claim 25, wherein the result is inputted by a user.
